(19) United States
(12) Patent Application Publication
(10) Pub. No.: US 2025/0161749 A1
(43) Pub. Date: May 22, 2025

(54) POSE RECOGNITION METHOD USING DEEP GAUSSIAN MIXTURE MODEL

(71) Applicant: ELECTRONICS AND TELECOMMUNICATIONS RESEARCH INSTITUTE, Daejeon (KR)

(72) Inventor: Jong Sung KIM, Daejeon (KR)

(73) Assignee: ELECTRONICS AND TELECOMMUNICATIONS RESEARCH INSTITUTE, Daejeon (KR)

(21) Appl. No.: 18/794,135

(22) Filed: Aug. 5, 2024

(30) Foreign Application Priority Data
Nov. 21, 2023 (KR) 10-2023-0162431

(51) Int. Cl. A63B 24/00; A63B 71/06; G06N 3/08

(52) U.S. Cl. CPC A63B 24/0006; A63B 71/0622; G06N 3/08; A63B 2024/0012; A63B 2024/0068; A63B 2071/0647; A63B 2220/05; A63B 2220/803; A63B 2220/806; A63B 2220/836; A63B 2230/62

(57) ABSTRACT

Proposed is a pose recognition method using a deep Gaussian mixture model. The pose recognition method includes receiving pose information of a user by an analysis apparatus, inputting the pose information of the user into an analysis model by the analysis apparatus, and outputting a pose recognition result on the basis of an output value of the analysis model by the analysis apparatus. The analysis model may be a deep Gaussian mixture model.

### CROSS REFERENCE TO RELATED APPLICATION

The present application claims priority to Korean Patent Application No. 10-2023-0162431, filed Nov. 21, 2023, the entire contents of which is incorporated herein for all purposes by this reference.

### BACKGROUND OF THE INVENTION

### Field of the Invention

The present disclosure relates to a method in which a computer recognizes poses.

### Description of the Related Art

In order for computers or robots to understand human behavior and communicate with humans in fields such as virtual reality and artificial intelligence, the computers need to understand human language and behavior. For this reason, pose recognition methods for recognizing human poses by computers have been developed.

Pose recognition methods have been used in a variety of fields. For example, in the gaming field, pose recognition methods recognize users' poses and apply recognition results to game characters, enabling the users to play games with the sense of reality. Alternatively, in the security field, pose recognition methods may help a security system determine that there is a significant security risk when a particular person performs a particular pose in a security-critical place.

Alternatively, in the exercise field, pose recognition methods recognize users' poses and may help analyze whether the recognized poses are correct poses.

The foregoing is intended merely to aid in the understanding of the background of the present disclosure, and is not intended to mean that the present disclosure falls within the purview of the related art that is already known to those skilled in the art.

### DOCUMENT OF RELATED ART

(Patent Document 1) U.S. Pat. No. 9,336,826 B2

### SUMMARY OF THE INVENTION

In the related art, an artificial neural network (ANN)-based deep learning model is used to recognize a user's poses. The artificial neural network-based deep learning model is one of the techniques for processing data using an artificial neural network that imitates human neurons. The artificial neural network-based deep learning model may process complex data. However, the artificial neural network-based deep learning model has a very complex structure and requires a large amount of training data and a considerable quantity of computer resources. In addition, the artificial neural network-based deep learning model is also called a black box model because it is difficult to explain how the model makes decisions.

The present disclosure discloses a method of recognizing a user's poses by using, rather than a deep learning model, a deep Gaussian mixture model that is very simple and interpretable. In addition, the present disclosure discloses a virtual exercise system using a pose recognition method.

The pose recognition method using the deep Gaussian mixture model includes: receiving, by an analysis apparatus, pose information of a user; inputting, by the analysis apparatus, the pose information of the user into an analysis model; and outputting, by the analysis apparatus, a pose recognition result on the basis of an output value of the analysis model. The analysis model may be a deep Gaussian mixture model.

A virtual exercise guidance method includes: outputting, by a virtual exercise system, a coach's pose to a user; acquiring, by the virtual exercise system, pose information of the user; recognizing, by the virtual exercise system, the user's pose through the analysis apparatus of claim 1; and comparing, by the virtual exercise system, the user's pose recognized and the coach's pose to evaluate the user's pose.

According to the present disclosure, a computer can recognize a user's pose from pose information of the user.

According to the present disclosure, a user's pose can be recognized using the deep Gaussian mixture model. Thus, the user's pose can be recognized without using a complex deep learning model.

According to the present disclosure, a user's pose can be recognized on the basis of only a small amount of information.

According to the present disclosure, the virtual exercise system for guiding and correcting a user's pose virtually can be established.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a diagram illustrating the overall process in which an analysis apparatus 100 performs a pose recognition method;

FIG. 2 is a flowchart 200 illustrating one example of a pose recognition method;

FIG. 3 is a diagram illustrating one example of a skeleton model;

FIG. 4 is a diagram illustrating one example of a deep Gaussian mixture model;

FIGS. 5 and 6 are diagrams illustrating one example of an inference process through a deep Gaussian mixture model;

FIG. 7 is a diagram illustrating one example of a process of training a deep Gaussian mixture model;

FIG. 8 is a flowchart 300 illustrating one example in which a virtual exercise guidance method is performed using a virtual exercise system;

FIGS. 9A to 9H are diagrams illustrating a coach's poses;

FIG. 10 is a diagram illustrating a result in which a user is exercising through a virtual exercise system;

FIG. 11 is a diagram illustrating the accuracy of a result of recognizing a user's poses;

FIG. 12 is a diagram illustrating a configuration of one example of an analysis apparatus 400; and

FIG. 13 is a diagram illustrating a configuration of one example of a virtual exercise system 500.

### DETAILED DESCRIPTION OF THE INVENTION

A variety of modifications may be made to the present disclosure and there are various embodiments of the present disclosure. The drawings in the specification may show particular embodiments of the present disclosure. However, this is for describing the present disclosure, and the present disclosure is not limited to the particular embodiments. Accordingly, it should be understood that all modifications, equivalents, or substitutes included in the technical idea and technical scope of the present disclosure are included in the technology described below.

In the terms used herein, an expression used in the singular encompasses the expression of the plural, unless the context clearly means otherwise. It will be furthermore understood that the terms “comprises”, “comprising”, “includes”, and “including” specify the presence of stated features, numbers, steps, operations, elements, components, or combinations thereof, but do not preclude the presence or addition of one or more other features, numbers, steps, operations, elements, components, or combinations thereof.

Before providing a detailed description of the drawings, it would be clarified that the division of elements in the specification is merely a division according to main functions each element is responsible for. That is, two or more elements, which will be described below, may be combined into one element, or one element may be divided into two or more parts for more detailed functions. In addition to the main functions that each element is responsible for, each of the elements may additionally perform some or all of the functions that the other elements are responsible for. Some of main functions each element is responsible for may be handled and performed by the other elements.

In addition, in performing a method or an operation method, steps constituting the method may occur in an order different from an order described herein unless a specific order is clearly stated in context. In other words, the steps may be performed in the same order as described, may be performed substantially simultaneously, or may be performed in the reverse order.

Hereinafter, the overall process in which an analysis apparatus 100 performs a pose recognition method using a deep Gaussian mixture model (hereinafter, referred to as a pose recognition method) will be described.

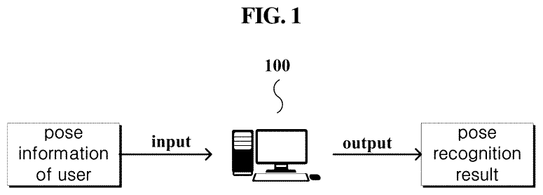

FIG. 1 is a diagram illustrating the overall process in which an analysis apparatus 100 performs a pose recognition method.

The analysis apparatus 100 may be physically realized in various forms. For example, the analysis apparatus 100 may be in the form of a PC, a laptop computer, a smart device, a server, or a chipset only for data processing.

The analysis apparatus 100 may receive pose information of a user and output a result of recognizing the user's pose.

Specifically, the analysis apparatus 100 may acquire the pose information of the user. The analysis apparatus 100 may input the pose information of the user into an analysis model. The analysis apparatus 100 may output a pose recognition result of the user on the basis of an output value of the analysis model.

Hereinafter, the pose recognition method will be described in detail.

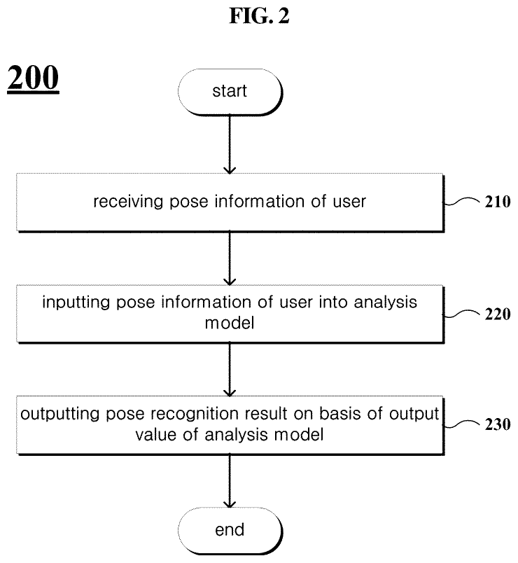

FIG. 2 is a flowchart 200 illustrating one example of a pose recognition method.

The analysis apparatus may receive pose information of a user in step 210.

The pose information of the user may be information required in recognizing the user's current pose. The pose information of the user may be information that includes 3D information related to the user's pose.

The pose information of the user may include a video of the user taken using a video acquisition device. The video acquisition device may be a color (RGB) camera. Alternatively, the video acquisition device may be a color (RGB-D) camera coupled with a depth camera.

The pose information of the user may include information on the user's movement measured using a sensor attached to a wearable device. The sensor attached to the wearable device may measure the movement of the user's whole body or on a part thereof. The sensor attached to the wearable device may be worn on the user's main joints. Examples of the sensor attached to the wearable device may include a movement sensor.

The pose information of the user may include at least one selected from the group of a position, a direction, and a speed of each part of the user's body. For example, the pose information of the user may include at least one selected from the group of a position, a direction, and a speed of a wrist of the user's body.

The pose information of the user may include pose information for a skeleton model representing the user. The skeleton model may be made up of a plurality of bones and a plurality of joints.

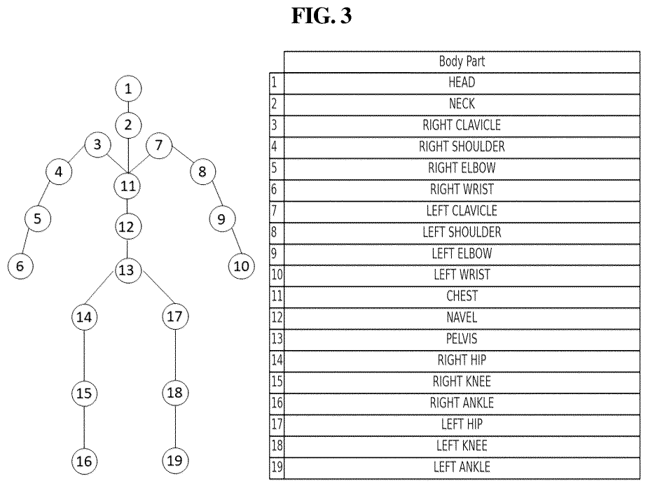

FIG. 3 is a diagram illustrating one example of a skeleton model.

The skeleton model may have 19 joints. The joints are [1: head], [2: neck], [3: right clavicle], [4: right shoulder], [5: right elbow], [6: right wrist], [7: left clavicle], [8: left shoulder], [9: left elbow], [10: left wrist], [11: chest], [12: navel], [13: pelvis], [14: right hip], [15: right knee], [16: right ankle], [17: left hip], [18: left knee], and [19: left ankle].

Equation 1 is one of the equations that represent the pose information (xₜ) for the skeleton model that may be acquired at any time t.

$${x}_{t} = ( {x}_{t , 1} , … , {x}_{t , 2} , … , {x}_{t , N} ) \qquad [ Equation 1 ]$$

In Equation 1, t denotes any time. In Equation 1, i denotes the i-th joint of the skeleton model. In Equation 1, N denotes the total number of joints of the skeleton model. Equation 1, x_{t,i} denotes the motion vector that represents the position, direction, or speed of the i-th joint of the skeleton model at any time t.

The pose information of the user may vary depending on the user's pose, physical conditions, and the time of acquisition. Pose distribution of the user may be defined as a Gaussian sum model (sum of gaussian) in terms of probability.

Equation 2 shows a Gaussian sum model for the user's poses.

$$p ( {x}_{t , i} \vert {Θ}_{i} ) = {\sum }_{k = 1}^{K} {π}_{i , k} G ( {x}_{t , i} \vert {A}_{i , k} ) \qquad [ Equation 2 ]$$

In Equation 2, x_{t,j} denotes the motion vector that represents the position, direction, or speed of the i-th joint at any time t. In Equation 2, θᵢ denotes the parameter of Gaussian sum probability distribution for the i-th joint. In Equation 2, K denotes the number of Gaussian distributions that are summed in the Gaussian sum model. In Equation 2, K is determined by the physical characteristics of the user's poses. In Equation 2, A_{i,k} denotes the parameter of Gaussian probability distribution for the i-th joint in the k-th pose. In Equation 2, π_{i,k} denotes the weighting of Gaussian probability for the i-th joint in the k-th pose.

Herein, the probability distributions of xₜ of the skeleton model for the user may be defined as a Gaussian product model (product of gaussians).

$$p ( {x}_{t} \vert Θ ) = {{\prod }^{N}}_{i = 1} p ( {x}_{t , i} \vert {Θ}_{i} ) \qquad [ Equation 3 ]$$

In Equation 3, xₜ denotes the pose information of the user that may be acquired at any time t. In Equation 3, θ denotes the parameter set of Gaussian probability distribution. In Equation 3, N denotes the total number of joints. In Equation 3, x_{t,i} denotes the motion vector that represents the position, direction, or speed of the i-th joint of the skeleton model at any time t. In Equation 3, θᵢ denotes the parameter set of Gaussian sum probability distribution for the i-th joint.

The analysis apparatus may input the pose information of the user into the analysis model in step 220.

The analysis model may be a model trained to output a pose recognition result on the basis of the pose information of the user. Specifically, the analysis model may be a model trained to output, when the pose information xₜ of the user at any time t is input, pose recognition information yₜ corresponding thereto.

The pose recognition information output by the analysis model may be a selection of one with the highest probability among a plurality of poses. For example, the analysis model may compute respective probability values for five poses from the pose information of the user, and may output the pose having the highest probability among the computed probability values, as the user's current pose.

Equation 4 shows pose recognition information output by the analysis model.

$${y}_{t} = ( {y}_{t , 1} , … , {y}_{t , j} , … , {y}_{t , K} ) \qquad [ Equation 4 ]$$

In Equation 4, yₜ denotes pose recognition information output by the analysis model. In Equation 4, y_{t,j} denotes a value (or probability) indicating the user's pose is the j-th pose at any time t.

Equation 5 is an equation used to select one with the highest probability among a plurality of poses. Specifically, Equation 5 is used when the pose with the highest probability is denoted by 1 and the other poses is denoted by 0.

$${y}_{t , j} = \{ \begin{matrix}1 & if j = arg max p ( {y}_{t , h} \vert {x}_{t} , Θ ) \\ 0 & o . w .\end{matrix} \qquad [ Equation 5 ]$$

In Equation 5, y_{t,j} denotes a value (or probability) indicating that the user's pose is the j-th pose at any time t. In Equation 5, xₜ denotes the pose information of the user. In Equation 5, 0 denotes the parameter set of Gaussian probability distribution.

The analysis model may be a deep Gaussian mixture model.

A Gaussian mixture model (GMM) may be a model that is a mixture of several Gaussian probability distributions. The Gaussian mixture model may be used in modeling data distribution. The Gaussian mixture model may be used in clustering similar data.

The deep Gaussian mixture model (DGMM) is one of the models that are mixtures of multi-layer structures and Gaussian mixture models in deep learning models.

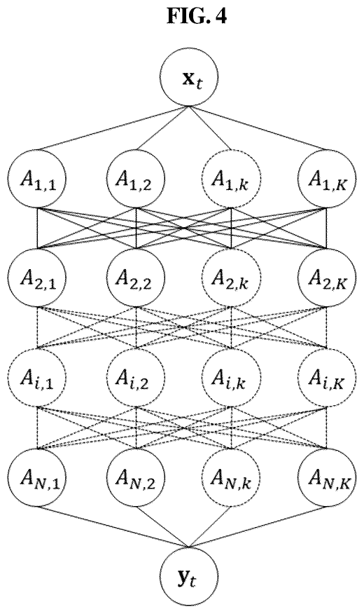

FIG. 4 is a diagram illustrating one example of a deep Gaussian mixture model.

Similarly to deep learning models, the deep Gaussian mixture model includes nodes and edges.

A node of the deep Gaussian mixture model may be the Gaussian probability distribution of the probability that the pose information is for a joint in a pose to be recognized. Specifically, a node of the deep Gaussian mixture model may be the Gaussian probability distribution for the i-th joint in the k-th pose. For example, node A_{2,3} may be the Gaussian probability distribution for the 2 (i=2)-th joint in the 3 (=k)-th pose.

An edge of the deep Gaussian mixture model may be a connection between Gaussian distribution and Gaussian distribution.

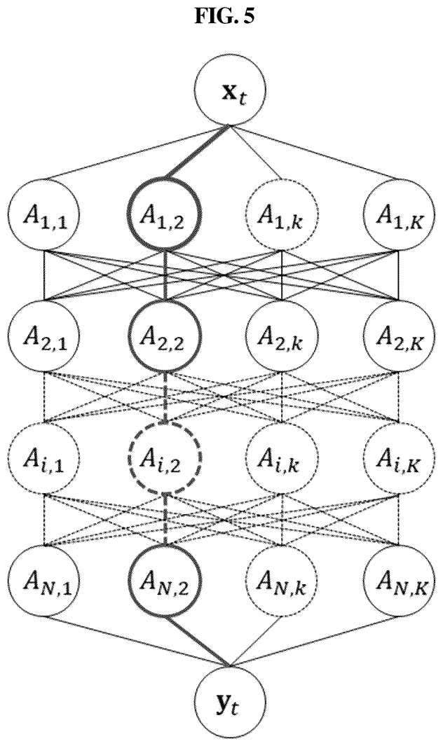

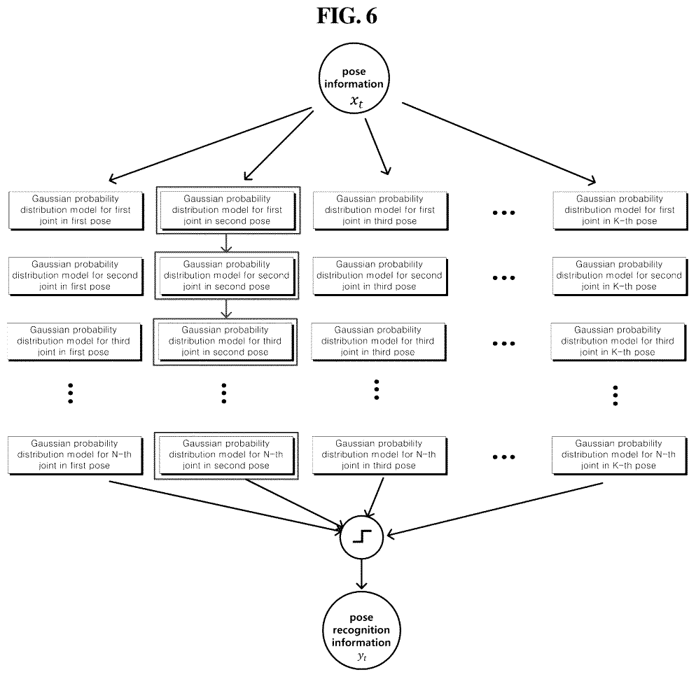

FIGS. 5 and 6 are diagrams illustrating one example of an inference process through a deep Gaussian mixture model.

The deep Gaussian mixture model may receive the pose information xₜ of the user at any time t. The total number of nodes of the deep Gaussian mixture model may be N×K. There may be a total of K^{N} paths from the input to the output of the deep Gaussian mixture model. The pose information of the user passes through the deep Gaussian mixture model along the paths determined by the trained parameters, and finally, a result yₜ of recognizing the pose with the highest probability is output.

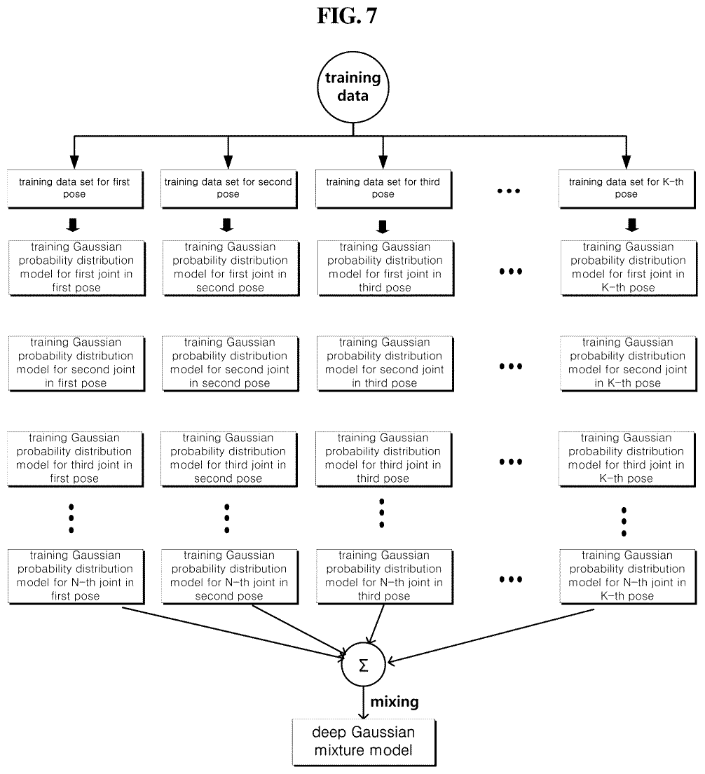

FIG. 7 is a diagram illustrating one example of a process of training a deep Gaussian mixture model.

In training data, a training data set for the k-th pose is used to learn the Gaussian probability distribution for the n-th joint in the k-th pose. Poses to be recognized are sequentially learned, starting from the first pose to the k-th pose. In addition, sequential learning is performed starting from the first joint to the N-th joint. After completing the training process for N joints for poses K, the Gaussian probability distribution models mixed to establish the deep Gaussian mixture model.

The analysis apparatus may output a pose recognition result on the basis of an output value of the analysis model in step 230.

The pose recognition result may include a result of recognizing what the user's pose is.

For example, the pose recognition result may include a result of recognizing the user's current pose as “lying down pose”. Alternatively, the pose recognition result may include a result of recognizing the user's current pose as “stretching pose”.

Hereinafter, a virtual exercise system using the above-described analysis apparatus will be described.

The virtual exercise system may be a system that helps a user exercises. The virtual exercise system may be a system that allows a user to exercise under a virtual coach's guidance.

The virtual exercise system may use the above-described analysis apparatus. Thus, the above-described analysis apparatus may be included in the virtual exercise system.

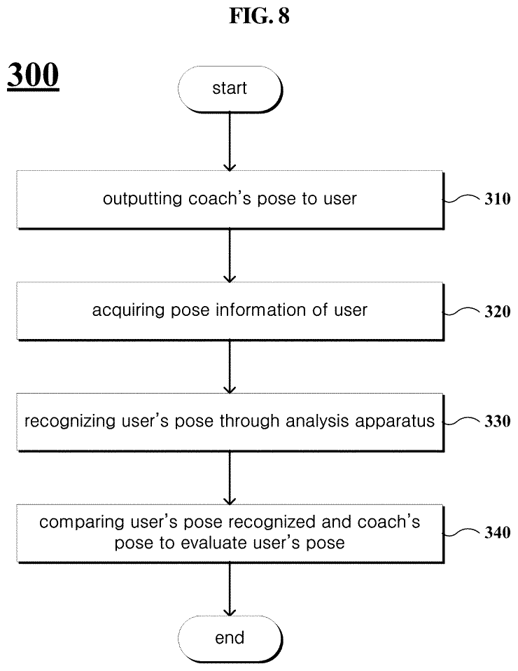

FIG. 8 is a flowchart 300 illustrating one example in which a virtual exercise guidance method is performed using a virtual exercise system.

The virtual exercise system may output a coach's poses to a user in step 310.

The coach's poses may be to lead the user who is exercising to exercise in correct poses. That is, the coach's poses may be guiding poses for doing exercise correctly. The virtual exercise system enables the user to see and follow the coach's poses.

The coach's poses may be poses the coach is doing in real time. In this case, the user may exercise, following the coach's poses in real time.

The coach's poses may be previously stored poses of the coach. In this case, the user may exercise, following the coach's poses stored.

The coach's poses may vary in type and sequence depending on the exercise program. For example, in the case of an aerobic exercise program, the coach's poses may include a running pose or a walking pose. Alternatively, in the case of a flexibility enhancement program, the coach's poses may include a foot-stretching pose or a stretching pose.

The virtual exercise system may acquire pose information of the user in step 320.

The pose information of the user may be the above-described pose information of the user. That is, the pose information of the user may be information required in recognizing the user's current pose.

The virtual exercise system may recognize the user's poses through the analysis apparatus in step 330.

The analysis model used by the virtual exercise system may be the analysis model of the above-described analysis apparatus. That is, the analysis model may be the deep Gaussian mixture model.

The virtual exercise system may compare the user's poses recognized to the coach's poses to evaluate the user's poses in step 340.

In an embodiment, the virtual exercise system may evaluate the user's poses depending on how well the user follows the coach's poses. For example, the user's pose may be appreciated when the coach performs the third pose among poses and it is recognized that the user performs the third pose equally.

If necessary, the virtual exercise system may notify the user of the user's evaluated pose.

Hereinafter, the establishment of the analysis model and a result of applying the established analysis model to the virtual exercise system will be described.

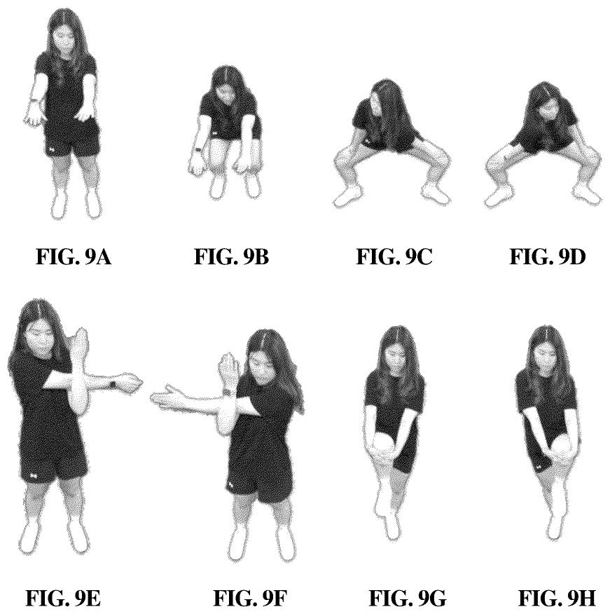

FIGS. 9A to 9H are diagrams illustrating a coach's poses. There may be a total of eight poses of the coach.

FIG. 9A shows a squat-up (SU) pose. FIG. 9B shows a squat-down (SD) pose. FIG. 9C shows a left-leg (LL) stretching pose. FIG. 9D shows a right-leg (RL) stretching pose. FIG. 9D shows a left-arm (LA) stretching pose. FIG. 9F shows a right-arm (RA) stretching pose. FIG. 9G shows a left-knee (LK) stretching pose. FIG. 9H shows a right-knee (RK) stretching pose.

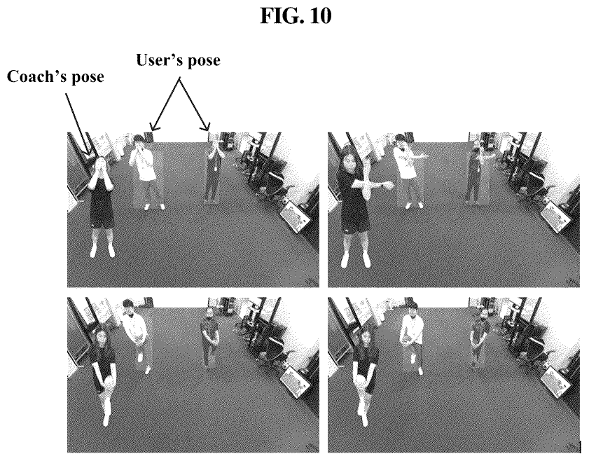

FIG. 10 is a diagram illustrating a result in which a user is exercising through a virtual exercise system.

The user may exercise while watching his or her poses displayed virtually. The virtual exercise system may compare the user's poses to the coach's poses to evaluate the user's poses.

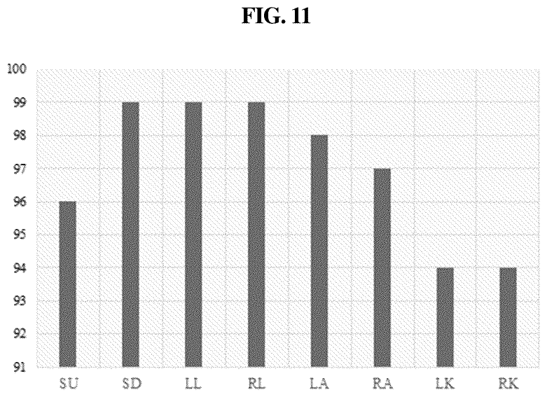

FIG. 11 is a diagram illustrating the accuracy of a result of recognizing a user's poses. It can be seen that the virtual exercise system recognized the user's poses accurately through the analysis apparatus with respect to most of the poses.

Hereinafter, the analysis apparatus will be described in detail.

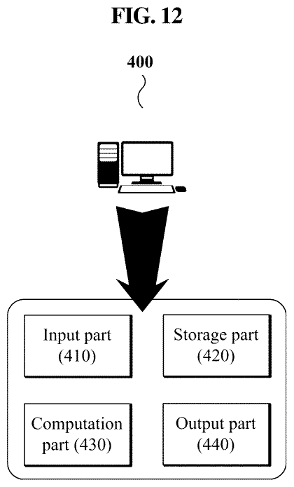

FIG. 12 is a diagram illustrating a configuration of one example of an analysis apparatus 400.

The analysis apparatus 400 may correspond to the analysis apparatus 100 described above with reference to FIG. 1. That is, the analysis apparatus 400 may be an apparatus that performs the above-described pose recognition method.

The analysis apparatus 400 may include an input part 410, a storage part 420, a computation part 430, and an output part 440.

The input part 410 may receive the pose information acquired by the virtual exercise system. The input part 410 may receive information required to perform the above-described pose recognition method. The input part 410 may receive a model required to perform the above-described pose recognition method. The input part 410 may receive information or a model from the virtual exercise system. The input part 410 may receive pose information of a user. The input part 410 may receive an analysis model.

The storage part 420 may be a device in which particular information is stored. The storage part 420 may store information received through the input part 410. The storage part 420 may store information generated during the computing process of the computation part 430. That is, the storage part 420 may include a memory. The storage part 420 may store information required to perform the above-described pose recognition method. The storage part 420 may store a model required to perform the above-described pose recognition method. The storage part 420 may store the pose information of the user. The storage part 420 may store the analysis model.

The computing part 430 may be a device, such as a processor, an AP, or a chip in which a program is embedded, for processing data and particular computations. The computation part 430 may generate control signals for controlling the analysis apparatus 400. The computation part 430 may generate the control signals for controlling the input part 410, the storage part 420, and the output part 440 included in the analysis apparatus 400. The computation part 430 may input the pose information of the user into the analysis model. The computation part 430 may recognize the user's pose on the basis of an output value of the analysis model.

The output part 440 may be a device that outputs particular information. The output part 440 may output information stored in the storage part 430. The output part 440 may output the information generated during the computing process of the computation part 430. The output part 440 may output results of computations by the computation part 430. The output part 440 may transmit information on the analysis apparatus 100 to other devices.

Hereinafter, the virtual exercise system will be described in detail.

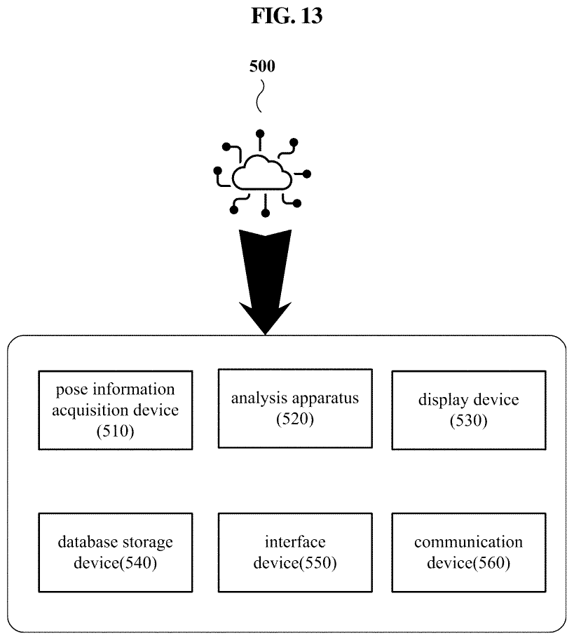

FIG. 13 is a diagram illustrating a configuration of one example of a virtual exercise system 500.

The virtual exercise system 500 may correspond to the virtual exercise system described above with reference to FIG. 8. That is, the virtual exercise system 500 may be an apparatus that performs the above-described virtual exercise guidance method.

The virtual exercise system 500 may include a pose information acquisition device 510, an analysis apparatus 520, a display device 530, a database storage device 540, an interface device 550, and a communication device 560.

The pose information acquisition device 510 may acquire pose information of a user. The pose information acquisition device 510 may include the video acquisition device. The pose information acquisition device 510 may include the sensor attached to the wearable device. The pose information of the user acquired by the pose information acquisition device 510 may be input to the analysis apparatus 520.

The analysis apparatus 520 may be the analysis apparatus described above with reference to FIGS. 1 and 12. Accordingly, the analysis apparatus 520 may receive the pose information of the user and output a result of recognizing the user's pose.

The display device 530 may show information required to perform the virtual exercise guidance method. The display device 530 may show a pose recognition result of the user. The display device 530 may show a result of evaluating the user's poses. The display device 530 may include a device, such as a monitor, for providing visual output.

The database storage device 540 may store a database required to perform the virtual exercise guidance method. The database storage device 540 may store pose information of a coach. The database storage device 540 may store the pose information of the user. The database storage device 540 may store an exercise program.

The interface device 550 may be a device for receiving particular commands and data from the outside. The interface device 550 may output a result of analysis by the analysis apparatus 520. The interface device 550 may receive information required to perform the above-described virtual exercise guidance method from a physically connected input device or an external storage device.

The communication device 560 may mean an element for receiving and transmitting particular information over a wired or wireless network. The communication device 560 may perform network communication, such as Wireless Fidelity (Wi-Fi), Wi-Fi Direct, Bluetooth, ultra-wide band (UWB), near-field communication (NFC), Universal Serial Bus (USB), High-Definition Multimedia Interface (HDMI), or a local area network (LAN)). The communication device 560 may transmit or receive information required in performing the above-described virtual exercise guidance method.

The above-described pose recognition method or virtual exercise guidance method may be realized as a program (or application) including a computer-executable algorithm.

The program may be stored and provided in a transitory or non-transitory computer-readable medium.

The transitory computer-readable medium refers to various RAMs such as static RAM (SRAM), dynamic RAM (DRAM), synchronous DRAM (SDRAM), Double Data Rate SDRAM (DDR SDRAM), Enhanced SDRAM (ESDRAM), synchronous DRAM (SLDRAM), and Direct Rambus RAM (DRRAM).

The non-transitory computer-readable medium refers to a medium that stores data semi-permanently and can be read by a device, rather than a medium, such as a register, a cache, and a memory, which stores data for a short period of time. Specifically, the various applications or programs described above may be stored and provided in the non-transitory computer-readable medium, such as a CD, a DVD, a hard disk, a Blu-ray disk, a USB, a memory card, a read-only memory (ROM), a programmable read-only memory (PROM), an erasable PROM (EPROM), an electrically EPROM (EEPROM), or a flash memory.

The embodiments and the accompanying drawings only clearly show part of the technical idea included in the above-described technology, and it is obvious that all modification and specific embodiments that can be easily inferred by those skilled in the art within the scope of the technical idea included in the specification and drawings of the above-mentioned technology are included in the scope of the above-described technology.

What is claimed is:

1. A pose recognition method using a deep Gaussian mixture model, the pose recognition method comprising:
receiving, by an analysis apparatus, pose information of a user;
inputting, by the analysis apparatus, the pose information of the user into an analysis model; and
outputting, by the analysis apparatus, a pose recognition result on the basis of an output value of the analysis model,
wherein the analysis model is a deep Gaussian mixture model.

2. The pose recognition method of claim 1, wherein the pose information is information measured by a sensor attached to a wearable device positioned on the user's whole body or on a part thereof.

3. The pose recognition method of claim 1, wherein the pose information of the user includes pose information for a skeleton model representing the user.

4. The pose recognition method of claim 1, wherein the pose information of the user includes at least one selected from a group of a position, a direction, and a speed of each part of the user's body.

5. The pose recognition method of claim 1, wherein each node of the deep Gaussian mixture model is Gaussian probability distribution of probability that the pose information is for a joint in a pose to be analyzed.

6. The pose recognition method of claim 1, wherein the deep Gaussian mixture model is a model generated by mixing Gaussian probability distributions for each joint in each pose.

7. An analysis apparatus, comprising:
an input part configured to receive pose information of a user;
a computation part configured to input the pose information of the user into an analysis model, and recognize a pose on the basis of an output value of the analysis model; and
a storage part configured to store the pose information of the user and the analysis model,
wherein the analysis model is a deep Gaussian mixture model.

8. The analysis apparatus of claim 7, wherein the pose information is information measured by a sensor attached to a wearable device positioned on the user's whole body or on a part thereof.

9. The analysis apparatus of claim 7, wherein the pose information of the user includes pose information for a skeleton model representing the user.

10. The analysis apparatus of claim 7, wherein the pose information of the user includes at least one selected from a group of a position, a direction, and a speed of each part of the user's body.

11. The analysis apparatus of claim 7, wherein each node of the deep Gaussian mixture model is Gaussian probability distribution of probability that the pose information is for a joint in a pose to be analyzed.

12. The analysis apparatus of claim 7, wherein the deep Gaussian mixture model is a model generated by mixing Gaussian probability distributions for each joint in each pose.

13. A virtual exercise guidance method, comprising:
outputting, by a virtual exercise system, a coach's pose to a user;
acquiring, by the virtual exercise system, pose information of the user;
recognizing, by the virtual exercise system, the user's pose through the analysis apparatus of claim 1; and
comparing, by the virtual exercise system, the user's pose recognized and the coach's pose to evaluate the user's pose.

14. The virtual exercise guidance method of claim 13, wherein the coach's pose is a previously stored pose of the coach.
